(19) United States
(12) Patent Application Publication
(10) Pub. No.: US 2026/0260522 A1
(43) Pub. Date: Sep. 3, 2026

(54) INFORMATION PROCESSING DEVICE, SENSOR DATA TRANSMISSION METHOD, AND PROGRAM RECORDING MEDIUM

(71) Applicant: NEC Corporation, Minato-ku, Tokyo (JP)

(72) Inventors: Shintaro CHIKU, Tokyo (JP); Naoko FUKUSHI, Tokyo (JP); Shuei YAMADA, Tokyo (JP); Masanori KUKI, Tokyo (JP); Shuhei MIZUGUCHI, Tokyo (JP); Kosei KOBAYASHI, Tokyo (JP)

(73) Assignee: NEC Corporation, Minato-ku, Tokyo (JP)

(21) Appl. No.: 18/879,534

(22) PCT Filed: Aug. 10, 2022
(86) PCT No.: PCT/JP2022/030520

§ 371 Date: Dec. 27, 2024

(51) Int. Cl. G07C 5/00; G06V 20/58

(52) U.S. Cl. CPC G07C 5/008; G06V 20/58

(57) ABSTRACT

An information processing device according to an aspect of the present disclosure includes: at least one memory storing instructions; and at least one processor configured to execute the instructions to: acquire a timing at which a mobile object, which is capable of switching between at least two driving modes including an autonomous driving mode for movement by autonomous driving and a non-autonomous driving mode, has switched from the autonomous driving mode to the non-autonomous driving mode; acquire sensor information from a sensor that determines the state of a road and is mounted on the mobile object; and transmit a predetermined host device, the sensor information and mode change information indicating the timing at which the mobile object has switched from the autonomous driving mode to the non-autonomous driving mode.

### TECHNICAL FIELD

The present invention relates to an information processing device, a server, an inspection system, a sensor data transmission method, and a program recording medium.

### BACKGROUND ART

PTL 1 discloses a degradation diagnosis system capable of diagnosing the degree of degradation of public facilities using an imaging device attached to a mobile object. According to PTL 1, the degradation diagnosis system includes a degradation degree analysis unit that analyzes a degradation degree of an object to be inspected appearing in a captured image captured by the imaging device. The degradation diagnosis system further includes a priority order calculation unit that calculates a priority order of the object to be inspected based on the degradation degree of the same object to be inspected appearing in the plurality of captured images and the driving condition information of the mobile object. For example, when a sudden steering wheel operation or a sudden braking operation is performed due to deterioration of the object to be inspected, the degradation diagnosis system performs an operation of raising the priority order of the object to be inspected.

### CITATION LIST

### Patent Literature

PTL 1: WO 2020/022042 A1

### SUMMARY OF INVENTION

### Technical Problem

In the degradation diagnosis system described above, in addition to the image imaged by the imaging device attached to the mobile object, the degradation degree and the priority order of the object to be inspected are calculated using the driving condition information of the mobile object. However, in this method, since the system depends on the image and the operation situation, there is a possibility that grasping of slight deterioration of the object to be inspected is delayed.

An object of the present invention is to provide an information processing device, a server, an inspection system, a sensor data transmission method, and a program recording medium that can contribute to improvement in performance of inspection of an object to be inspected using a mobile object.

### Solution to Problem

According to a first point of view, provided is an information processing device including a first acquisition means for acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode, a second acquisition means for acquiring sensor information from a sensor that determines a state of an object to be inspected, the sensor being mounted on the mobile object, and a transmission means for transmitting, to a predetermined host device, mode change information indicating a timing at which the automatic driving mode has been switched to the non-automatic driving mode and the sensor information.

According to a second point of view, provided is a server including a reception means for receiving the mode change information and the sensor information from the information processing device described above, and a determination means for determining a state of an object to be inspected using the mode change information and the sensor information.

According to a third point of view, provided is an inspection system including the information processing device described above, and the server as described above.

According to a fourth point of view, provided is a sensor data transmission method including acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode, acquiring sensor information from a sensor that determines a state of an object to be inspected, the sensor being mounted on the mobile object, and transmitting, to a predetermined host device, the sensor information and mode change information indicating a timing at which the automatic driving mode has been switched to the non-automatic driving mode.

According to a fifth point of view, provided is a program recording medium recording a program for causing a computer to execute the steps of
acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode, acquiring sensor information from a sensor that determines a state of an object to be inspected, the sensor being mounted on the mobile object, and transmitting, to a predetermined host device, the sensor information and mode change information indicating a timing at which the automatic driving mode has been switched to the non-automatic driving mode.

### Advantageous Effects of Invention

According to the present invention, provided is an information processing device, a server, an inspection system, a sensor data transmission method, and a program recording medium that can contribute to improvement in performance of inspection of an object to be inspected using a mobile object.

### BRIEF DESCRIPTION OF DRAWINGS

FIG. 1 is a diagram illustrating a configuration of an example embodiment of the present invention.

FIG. 2 is a diagram for describing an operation of an example embodiment of the present invention.

FIG. 3 is a diagram for describing an image provided by an information processing device according to an example embodiment of the present invention.

FIG. 4 is a diagram for describing an image provided by an information processing device illustrated as a comparative example.

FIG. 5 is another diagram for describing an image provided by the information processing device according to an example embodiment of the present invention.

FIG. 6 is a diagram illustrating a configuration of the first example embodiment of the present invention.

FIG. 7 is a functional block diagram illustrating a configuration of a control center device according to the first example embodiment of the present invention.

FIG. 8 is a flowchart illustrating an operation of a control center device according to the first example embodiment of the present invention.

FIG. 9 is a diagram illustrating an example of an image (without mode change information) provided by the control center device to the analysis server.

FIG. 10 is a diagram illustrating an example of an image provided to the server by the control center device according to the first example embodiment of the present invention.

FIG. 11 is a diagram illustrating a configuration of the second example embodiment of the present invention.

FIG. 12 is a functional block diagram illustrating a configuration of a control center device according to the second example embodiment of the present invention.

FIG. 13 is a flowchart illustrating an operation of a control center device according to the second example embodiment of the present invention.

FIG. 14 is a diagram illustrating an example of data provided to the server by the control center device according to the second example embodiment of the present invention.

FIG. 15 is a diagram illustrating a configuration of the third example embodiment of the present invention.

FIG. 16 is a functional block diagram illustrating a configuration of a control center device according to the third example embodiment of the present invention.

FIG. 17 is a flowchart illustrating an operation of a control center device according to the third example embodiment of the present invention.

FIG. 18 is a diagram illustrating an example of data provided to the server by the control center device according to the third example embodiment of the present invention.

FIG. 19 is a diagram illustrating a configuration of the fourth example embodiment of the present invention.

FIG. 20 is a functional block diagram illustrating a configuration of a control center device according to the fourth example embodiment of the present invention.

FIG. 21 is a flowchart illustrating an operation of a control center device according to the fourth example embodiment of the present invention.

FIG. 22 is a diagram illustrating an example of data provided to the server by the control center device according to the fourth example embodiment of the present invention.

FIG. 23 is a diagram illustrating a configuration of the fifth example embodiment of the present invention.

FIG. 24 is a functional block diagram illustrating a configuration of an in-vehicle terminal according to the fifth example embodiment of the present invention.

FIG. 25 is a flowchart illustrating an operation of an in-vehicle terminal according to a fifth example embodiment of the present invention.

FIG. 26 is a diagram illustrating a configuration of a computer that can function as an information processing device of the present invention.

### EXAMPLE EMBODIMENT

First, an outline of an example embodiment of the present invention will be described with reference to the drawings. The reference signs in the drawings attached to this outline are attached to respective elements for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input to output of each block in the drawing, illustration thereof is omitted.

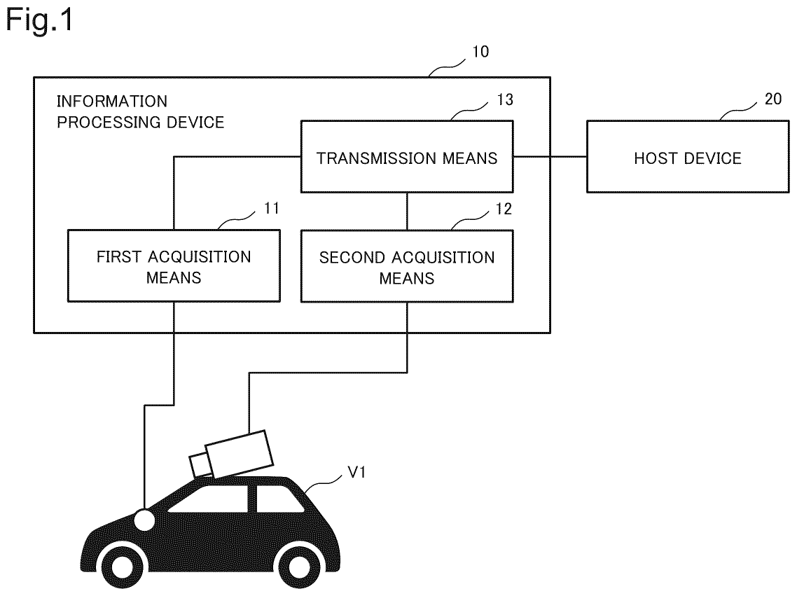

As illustrated in FIG. 1, the present invention, in an example embodiment thereof, can be achieved by a configuration including an information processing device 10 capable of communicating with a mobile object V1 capable of switching between at least two driving modes including an automatic driving mode in which the mobile object moves by automatic driving and a non-automatic driving mode, and a host device 20 that receives sensor information from the information processing device 10.

More specifically, the information processing device 10 includes a first acquisition means 11, a second acquisition means 12, and a transmission means 13. The first acquisition means 11 acquires the timing at which the mobile object V1 has been switched from the automatic driving mode to the non-automatic driving mode. The second acquisition means 12 acquires sensor information from a sensor that determines a state of an object to be inspected, the sensor being mounted on a mobile object. The transmission means 13 transmits mode change information indicating a timing at which the automatic driving mode has been switched to the non-automatic driving mode and sensor information to a predetermined host device.

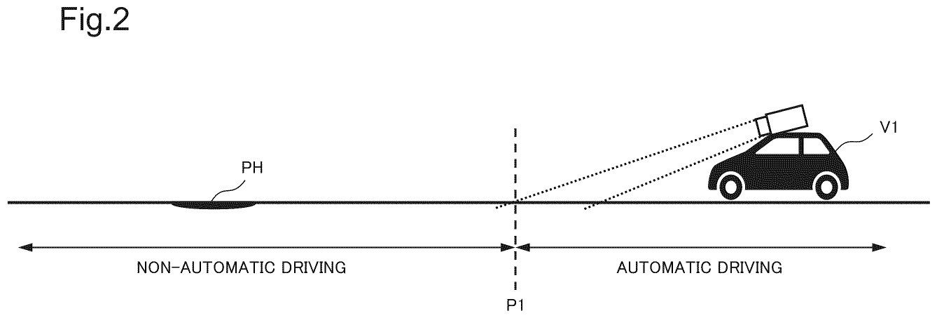

For example, as illustrated in FIG. 2, there will be described an example in which a pot hole PH is formed on the road surface at the traveling destination of the mobile object V1, and this is desired to be detected as an abnormality. A dotted line extending from a sensor mounted on the vehicle in FIG. 2 indicates a sensing range of the sensor. The point P1 indicates a point where the driver of the mobile object V1 or a person (operator) who performs remote control has switched from the automatic driving mode to the non-automatic driving mode from the viewpoint of improving safety by visually recognizing the pot hole PH. The non-automatic driving mode may include a direct driving mode (manual driving mode) in which the driver manually drives, a remote driving mode in which the remote control center remotely drives, or the like.

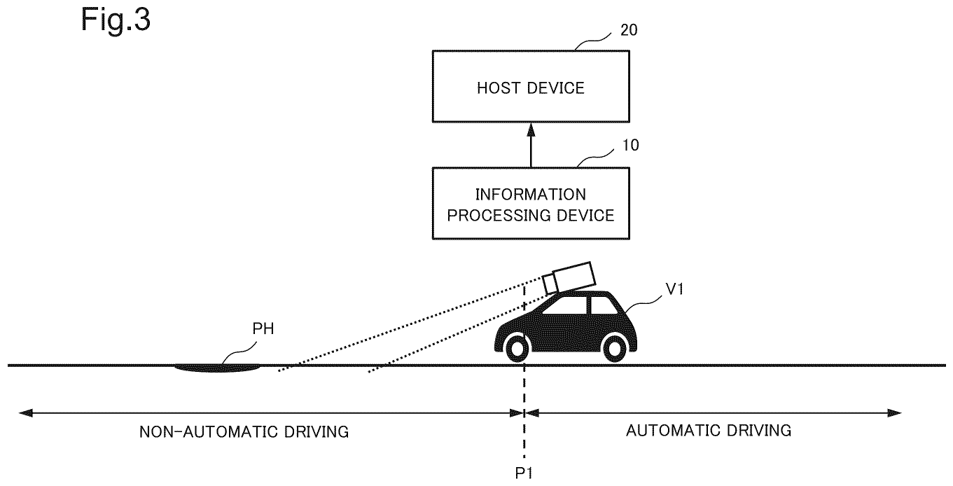

As illustrated in FIG. 3, when the automatic driving mode is switched to the non-automatic driving mode, the information processing device 10 of the present example embodiment transmits mode change information and sensor information to the host device 20. As a result, as illustrated in FIG. 3, the host device 20 can perform detailed analysis of the sensor information before the pot hole PH. As a result, cracks and the like on the road surface in front of the pot hole PH can be found at an early stage.

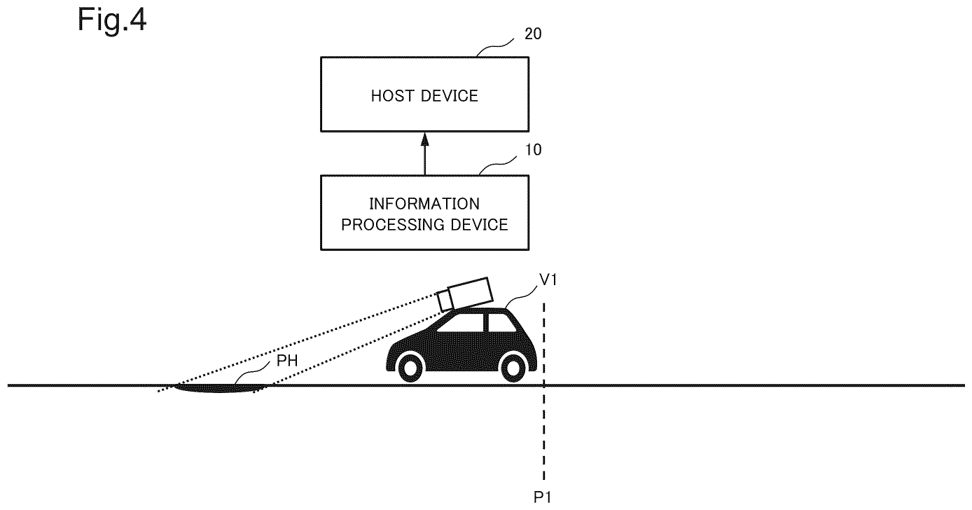

FIG. 4 is an image diagram in a case where sensor information is analyzed using the method described in the background art. As illustrated in FIG. 4, although the degradation degree of the road surface can be grasped from the sensor information, information about the timing at which the automatic driving mode has been switched to the non-automatic driving mode cannot be obtained. Even if there is a crack or the like on the road surface in front of the pot hole PH, there is a possibility that the crack or the like is overlooked.

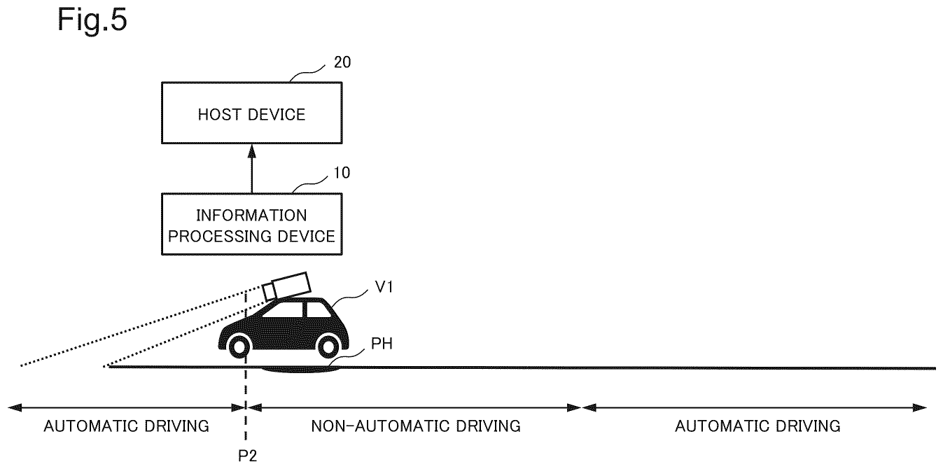

The information processing device 10 of the present example embodiment may promptly transmit the mode change information and the sensor information to the host device 20 even in a case where the non-automatic driving mode is switched to the automatic driving mode. For example, the point P2 in FIG. 5 indicates a point where the non-automatic driving mode is switched to the automatic driving mode. In this case, when the automatic driving mode is switched to the non-automatic driving mode, the information processing device 10 promptly transmits mode change information indicating that the mode returns to the automatic driving mode and sensor information to the host device 20. In this way, the host device 20 can end the detailed analysis of the sensor information. As a result, the transmission cost of the sensor information and the calculation cost of the host device 20 can be reduced.

As described above, according to the present example embodiment, it is possible to improve the performance of the inspection of the object to be inspected using the mobile object V1. In the above example, an example in which the driver of the mobile object V1 or the operator of the remote control center switches from the automatic driving mode to the non-automatic driving mode is described, but the entity of switching from the automatic driving mode to the non-automatic driving mode is not limited to these persons. For example, in a case where it is determined that the automatic driving is not allowed based on the information sensed by the mobile object, the mobile object V1 itself may switch the mode to the non-automatic driving mode. In this case, the mobile object V1 performs an operation of transmitting the mode change information and the sensor information to the host device 20 after making a notification to the driver and the operator of the remote control center. As a case where the mobile object V1 itself determines that automatic driving is not allowed, a case where the mobile object V1 detects an abnormality with respect to a road or a surrounding situation, a case where the mobile object V1 detects erroneous recognition with respect to the road or the surrounding situation, or the like is considered. The automatic driving may include autonomous driving for autonomously determining whether traveling is allowed based on information sensed by the mobile object V1.

### First Example Embodiment

Next, a function as an information processing device of the present invention will be described in detail with reference to the drawings in the first example embodiment disposed in a control center device 100 that controls a mobile object. In the following description, an example in which the mobile object is a bus having an automatic driving function will be described.

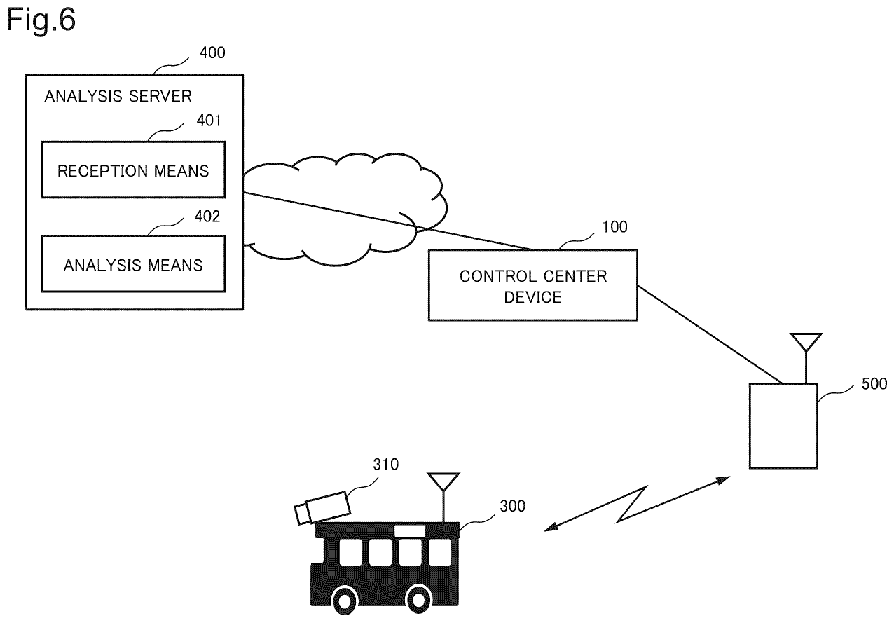

FIG. 6 is a diagram illustrating a configuration of the first example embodiment of the present invention. Referring to FIG. 6, a configuration of a road inspection system including the control center device 100, a bus 300, a base station 500 of a mobile object communication network that achieves communication between the bus 300 and the control center device 100, and an analysis server 400 is illustrated.

The bus 300 can switch between an automatic driving mode in which automatic driving is performed based on information sensed by the bus and a remote driving mode in which operation is performed by remote control from the control center device 100. It is assumed that the bus 300 includes a camera 310 capable of capturing an image in front of the bus 300 as a sensor. Switching between the automatic driving mode and the remote driving mode may be performed by the bus 300 or may be performed by the control center device 100. In the following description, it is assumed that an operator OP of the control center device 100 switches between the automatic driving mode and the remote driving mode with reference to the image by the camera 310. In addition to the automatic driving mode and the remote driving mode, the bus 300 may include, for example, a manual driving mode. The switching of the driving mode in this case may be performed by the bus 300 or may be performed by the control center device 100.

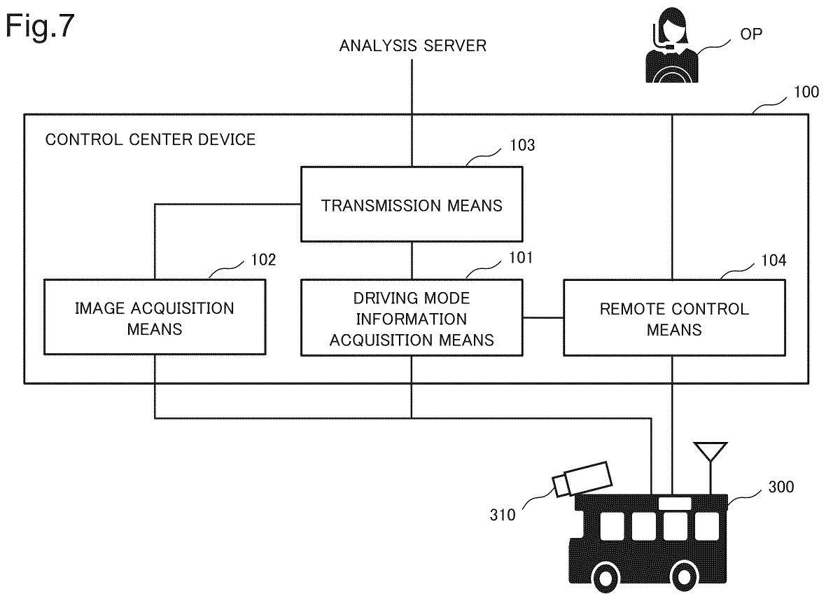

FIG. 7 is a functional block diagram illustrating a configuration of the control center device 100 according to the first example embodiment of the present invention. Referring to FIG. 7, a configuration of the control center device 100 including a driving mode information acquisition means 101, an image acquisition means 102, a transmission means 103, and a remote control means 104 is illustrated.

The remote control means 104 provides the operator OP with information of the instrument mounted on the bus and an image by the camera 310 using a display device or the like (not illustrated). The operator OP operates the bus 300 based on the information provided from the remote control means 104. Specifically, the remote control means 104 receives a steering operation for the bus 300 and a command given to the bus 300 from the information operator OP, and remotely controls the bus 300.

The driving mode information acquisition means 101 acquires the driving mode information of the bus 300 from the remote control means 104. When the driving mode of the bus 300 is changed, the driving mode information acquisition means 101 creates mode change information indicating the timing at which the driving mode is switched. Therefore, the driving mode information acquisition means 101 functions as the first acquisition means 11 that acquires the timing at which the automatic driving mode has been switched to the non-automatic driving mode. The mode change information may include, for example, information about the changed driving mode and time information indicating the change timing.

The image acquisition means 102 acquires an image from the camera 310 mounted on the bus 300. Therefore, the image acquisition means 102 functions as the second acquisition means 12 that acquires sensor information from a sensor that determines a state of the object to be inspected, the sensor being mounted on the mobile object.

The transmission means 103 transmits the mode change information and the camera image to the analysis server 400 as a host device. The transmission timings of the mode change information and the camera image are not necessarily the same. For example, the camera image may be periodically transmitted, and the mode change information may be transmitted only when necessary. Even in such a transmission mode, the analysis server 400 can analyze the image without any problem with reference to the mode change information.

The analysis server 400 includes a reception means (reference sign 401 in FIG. 6) that receives the mode change information and the sensor information, and a determination means (reference sign 402 in FIG. 6) that determines the state of the road using the mode change information and the sensor information.

The base station 500 is a base station of a fifth-generation mobile communication system (5G) or long term evolution (LTE).

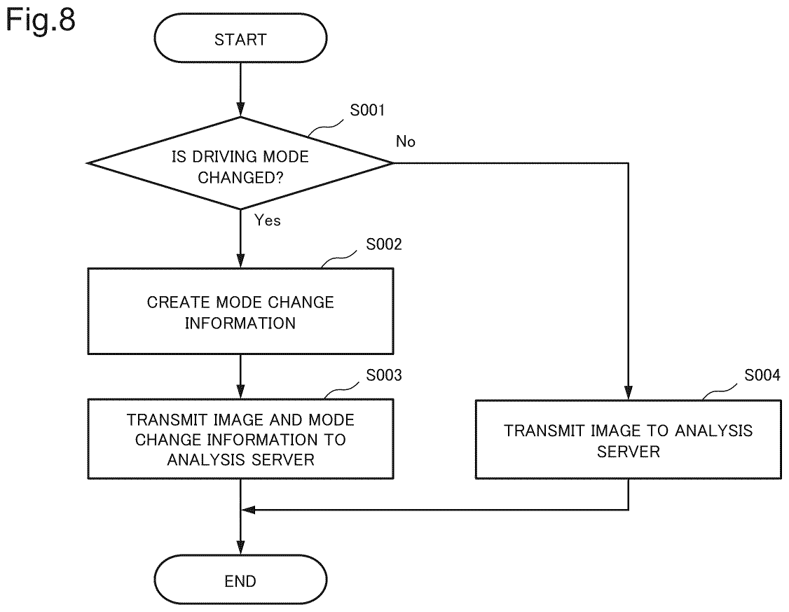

Next, the operation of the present example embodiment will be described in detail with reference to the drawings. FIG. 8 is a flowchart illustrating an operation of the control center device 100 according to the first example embodiment of the present invention. Referring to FIG. 8, first, the control center device 100 checks whether the driving mode has been changed (step S001).

As a result of the checking process, in a case where the driving mode is not changed, the control center device 100 transmits the image acquired from the camera 310 to the analysis server 400 (step S004).

On the other hand, when the driving mode is changed, the control center device 100 creates mode change information indicating the timing at which the driving mode is switched (step S002).

Next, the control center device 100 transmits the mode change information and the image acquired from the camera 310 to the analysis server 400 (step S003).

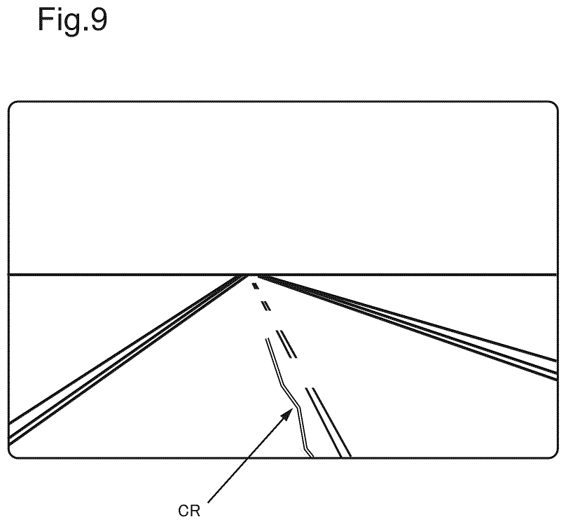

FIG. 9 is a diagram illustrating an example of an image (without mode change information) provided by the control center device 100 to the analysis server 400. In the example of FIG. 9, an image of a road captured by the camera 310 of the bus 300 is illustrated. In the example of FIG. 9, a crack CR is generated near the center line at the center of the road. Since such a crack CR may affect the automatic driving, the operator OP switches from the automatic driving mode to the remote driving mode at the time when the operator OP feels an abnormality at a distant place.

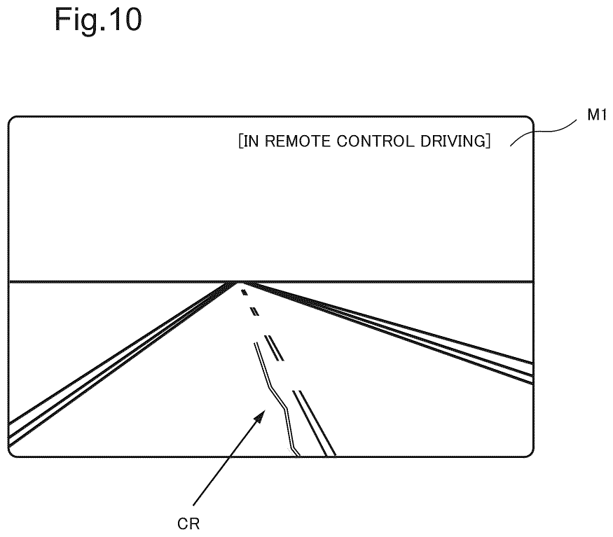

FIG. 10 is a diagram illustrating an example of an image provided by the control center device 100 to the analysis server 400 using the mode change information. In the example of FIG. 10, a message M1 of “in remote control driving” is added to the upper right of the image. In the example of FIG. 10, “in remote control driving” is displayed, but “in automatic driving” is displayed during automatic driving. The person in charge who is browsing the analysis server 400 and the display device can detect the abnormality of the road at an early stage by such a change in the display of the driving mode. The analysis server 400 changes the analysis mode of the image according to the change of the driving mode, so that the detection of the start point of the crack CR and the like is also facilitated.

When the section in which the abnormality of the road is recognized is ended, the operator OP switches from the remote driving mode to the automatic driving mode. In this case, the control center device 100 acquires the second mode change information indicating a timing at which the non-automatic driving mode has been switched to the automatic driving mode, to transmit the second mode change information to the analysis server 400. As a result, the display of “in remote control driving” is switched to “in automatic driving”. The person in charge who is browsing the analysis server 400 and the display device can sense the end of the abnormal section of the road by such a change in the display of the driving mode. The analysis server 400 changes the analysis mode of the image according to the change of the driving mode, whereby the detection of the end point of the crack CR and the like is facilitated. In the examples of FIGS. 9 and 10, an example of detecting a crack as an abnormality of a road is described, but the abnormality that can be detected by the analysis server 400 is not limited to a crack. By mounting the inspection function according to the type of the object to be inspected on the analysis server 400, it is possible to detect other abnormalities of the road and inspection of structures other than the road.

### Second Example Embodiment

In the above example embodiment, it is described that the control center device 100 transmits an image to the analysis server 400, but other sensor data can be received from the bus 300 and transmitted to the analysis server 400. Hereinafter, the second example embodiment in which a control center device 100a transmits sensor information to the analysis server 400 will be described.

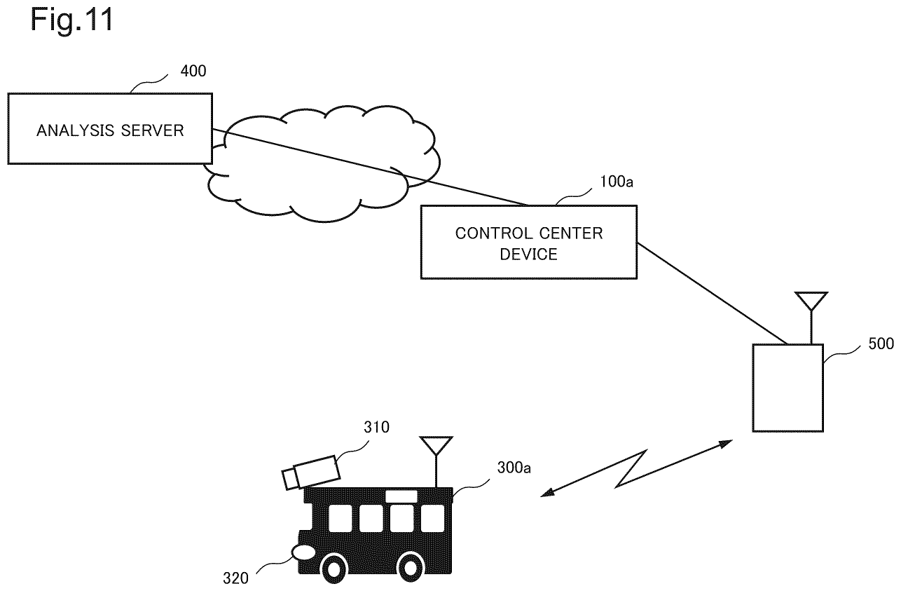

FIG. 11 is a diagram illustrating a configuration of the second example embodiment of the present invention. Referring to FIG. 11, a configuration including a control center device 100a, a bus 300a including a sensor 320, the base station 500 of a mobile object communication network that achieves communication between the bus 300a and the control center device 100a, and the analysis server 400 is illustrated. The present example embodiment is different from the first example embodiment in that the bus 300a includes the sensor 320 and the control center device 100a has a transmission function of the sensor 320. Since the other configurations are similar to those of the first example embodiment, differences thereof will be mainly described below.

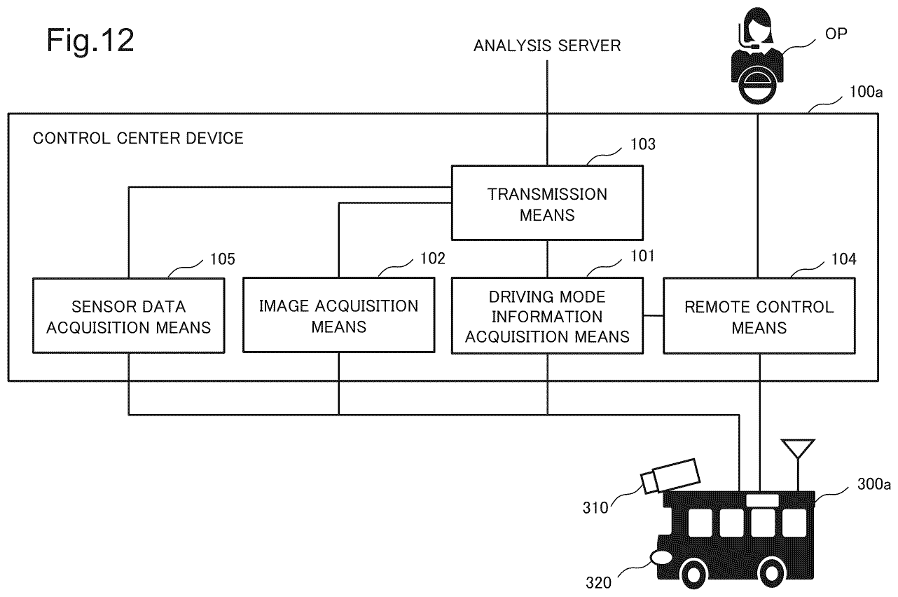

FIG. 12 is a functional block diagram illustrating a configuration of the control center device 100a of the second example embodiment using the sensor data transmission method of the present invention. A difference from the control center device 100 of the first example embodiment illustrated in FIG. 7 is that the control center device 100a includes a sensor data acquisition means 105, and the transmission means 103 is configured to transmit an image and sensor data to the analysis server 400.

The sensor data acquisition means 105 acquires sensor data from the sensor 320 mounted on the bus 300a. Examples of the sensor 320 include a vehicle speed meter, steering angle information, global positioning system (GPS) information, light detection and ranging (LiDAR), an acceleration sensor, and a millimeter wave radar.

The transmission means 103 transmits the driving mode information, the camera image, and the sensor data described above to the analysis server 400 in association with one another.

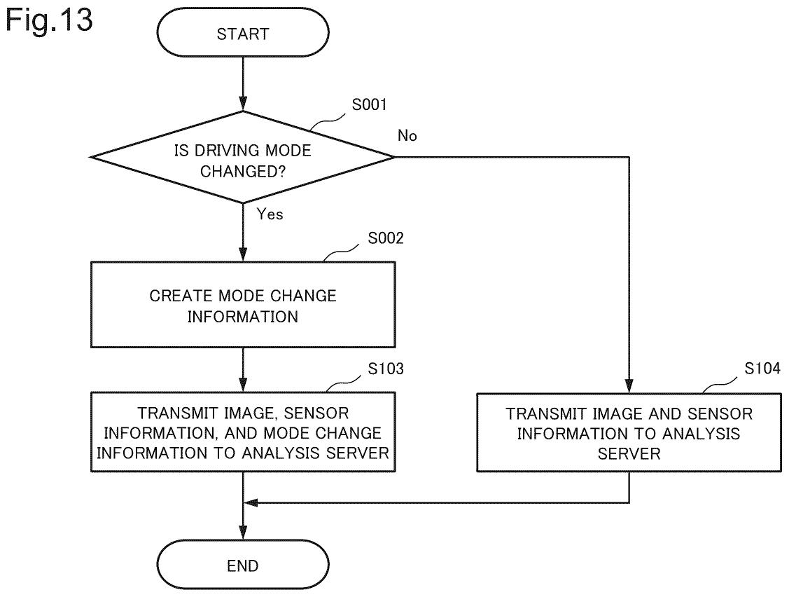

Next, the operation of the present example embodiment will be described in detail with reference to the drawings. FIG. 13 is a flowchart illustrating an operation of the control center device 100a according to the second example embodiment of the present invention. A difference from the operation of the control center device 100 of the first example embodiment illustrated in FIG. 8 is that the control center device 100a transmits sensor data in addition to an image to the analysis server 400 in steps S103 and S104.

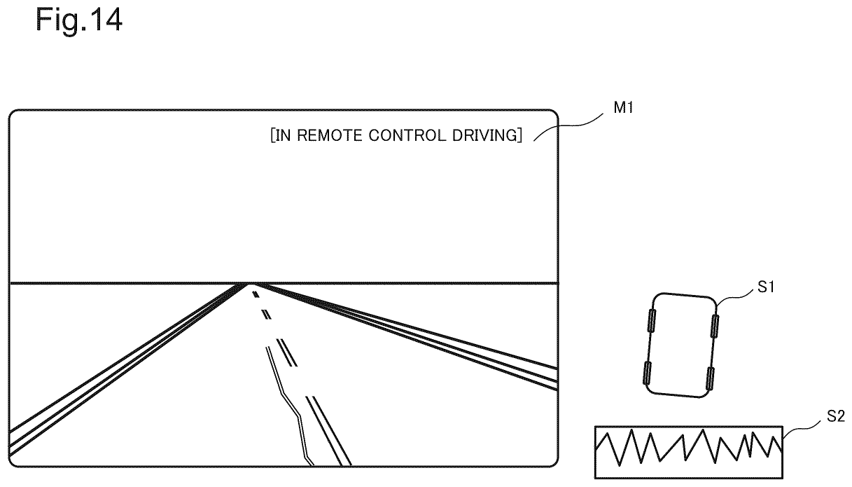

FIG. 14 is a diagram illustrating an example of an image provided to the analysis server 400 by the control center device 100a using various types of information obtained from the bus 300a. In the example of FIG. 14, in addition to the image similar to that of the first example embodiment, display using sensor data is performed on the right side of FIG. 14. Reference sign S1 represents, for example, the direction of the bus 300a (heading information) from the steering angle of the steering wheel and the GPS information. Reference sign S2 indicates a value of the acceleration sensor in the Z direction (vertical direction) of the bus 300a.

According to the present example embodiment, since the direction (heading) of the bus 300a and the acceleration change in the Z direction (vertical direction) can be checked as described above in addition to the display of the driving mode, the start point of the crack CR and the like can be more easily detected.

### Third Example Embodiment

Next, the third example embodiment in which a control center device 100b transmits an object recognition result in an image to the analysis server 400 in addition to the image and the sensor data will be described.

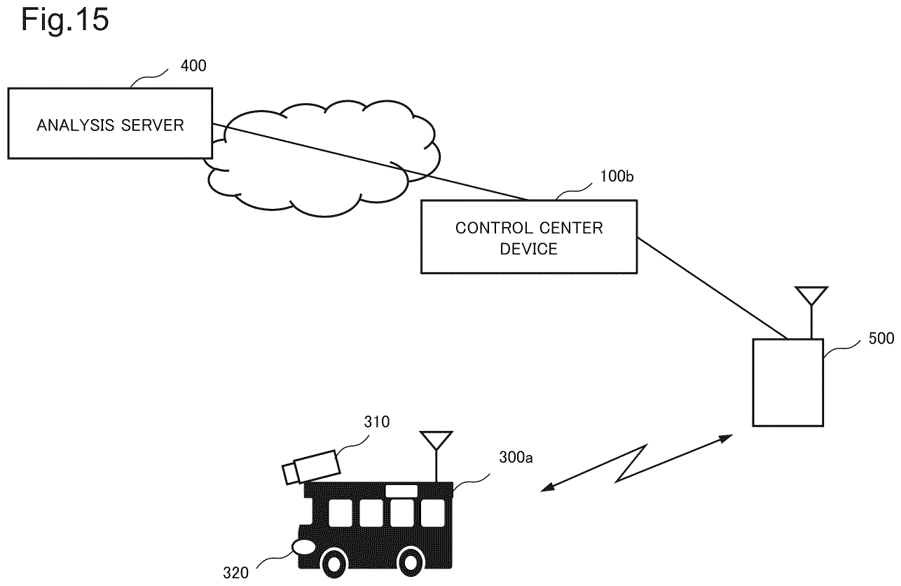

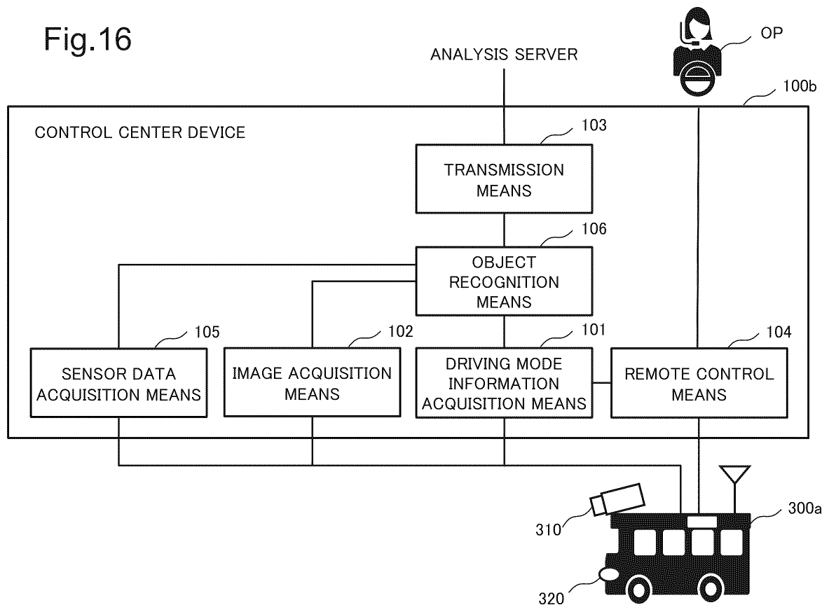

FIG. 15 is a diagram illustrating a configuration of the third example embodiment of the present invention. Referring to FIG. 15, a configuration including the control center device 100b, the bus 300a, the base station 500, and the analysis server 400 is illustrated. FIG. 16 is a functional block diagram illustrating a configuration of the control center device 100b according to the third example embodiment of the present invention. A difference from the control center device 100a of the second example embodiment illustrated in FIG. 12 is that the control center device 100b includes an object recognition means 106, and the transmission means 103 is configured to transmit an object recognition result to the analysis server 400 together with the image and the sensor data.

The object recognition means 106 performs recognition processing of an object appearing in an image from the camera 310 mounted on the bus 300. The object recognition means 106 may perform the object recognition process by checking a position using sensor data, for example, GPS information, or the like from the sensor 320 as necessary. The object recognition process in the object recognition means 106 can be performed, for example, by inputting an image itself or data obtained by cutting out a portion in which an object appears in the image to a classifier created in advance using machine learning or the like.

The transmission means 103 transmits the driving mode information, the camera image, the sensor data, and the object recognition result to the analysis server 400 in association with one another.

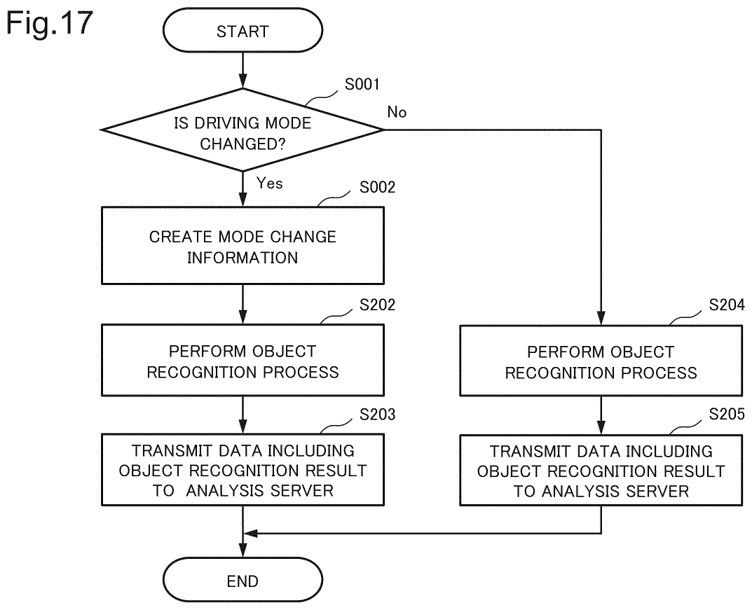

Next, the operation of the present example embodiment will be described in detail with reference to the drawings. FIG. 17 is a flowchart illustrating an operation of the control center device 100b according to the third example embodiment of the present invention. The first difference from the operation of the control center device 100a of the second example embodiment illustrated in FIG. 13 is that the control center device 100b performs the object recognition process in steps S202 and S204 by the control center device 100b. The second difference from the operation of the control center device 100a of the second example embodiment is that the control center device 100b transmits the object recognition result in addition to the image, the sensor data, and the like to the analysis server 400 in steps S203 and S205.

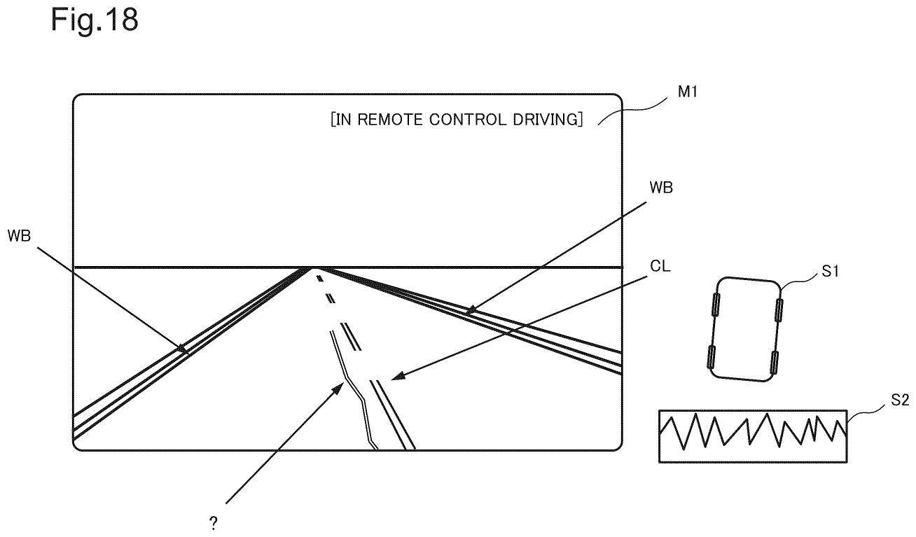

FIG. 18 is a diagram illustrating an example of an image provided by the control center device 100b to the analysis server 400. In the example of FIG. 18, in addition to the image similar to that of the second example embodiment, an object recognition result of a structure or the like shown in the image is added. Specifically, in the example of FIG. 18, results of object recognition of the white lines WB on both sides of the road, the center lines CL, and the like are added. In the example of FIG. 18, the mark “?” is s added to a crack that was not be able to be identified as a result of the object recognition.

According to the present example embodiment, since the result of the object recognition can be checked in addition to the display of the driving mode and the display of the sensor value, the detection of cracks and the like is further facilitated. As illustrated in FIG. 18, it is also possible to prevent overlooking of the abnormality by adding the mark “?” or highlighting for an unrecognized object.

### Fourth Example Embodiment

Next, the fourth example embodiment in which a control center device 100c has the estimation function of the switching cause of the driving mode will be described.

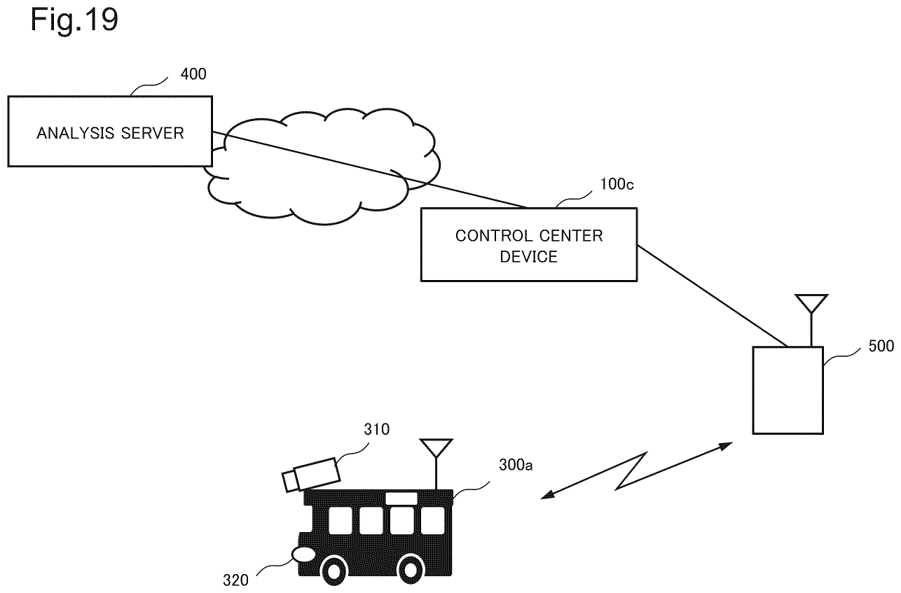

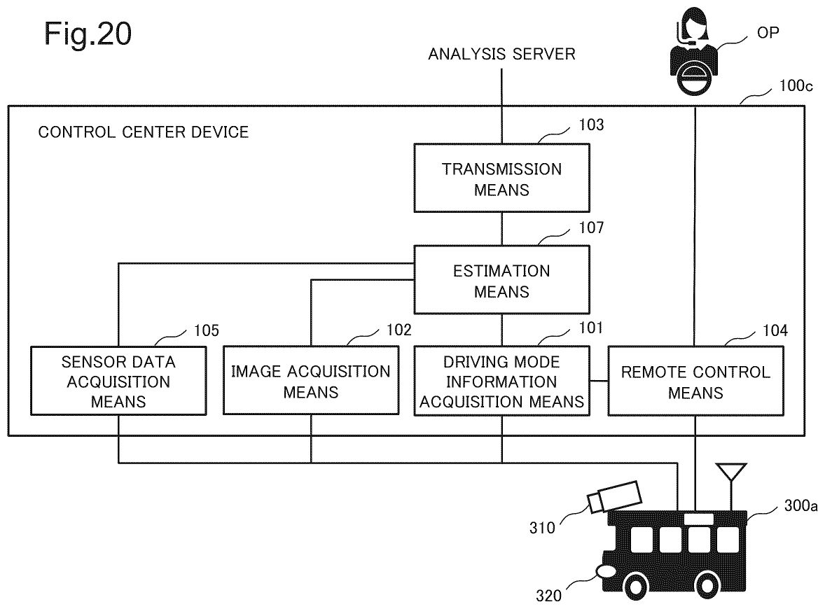

FIG. 19 is a diagram illustrating a configuration of the fourth example embodiment of the present invention. Referring to FIG. 19, a configuration including the control center device 100c, the bus 300a, the base station 500, and the analysis server 400 is illustrated. FIG. 20 is a functional block diagram illustrating a configuration of a control center device 100c according to the fourth example embodiment of the present invention. A difference from the control center device 100a of the second example embodiment illustrated in FIG. 12 is that the control center device 100c has an estimation means 107.

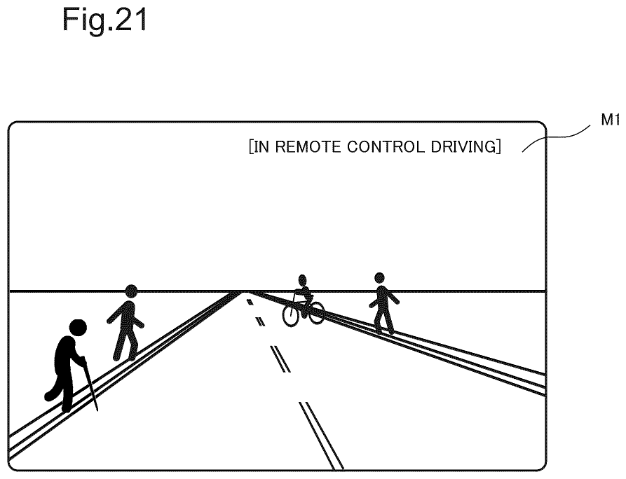

When the switching of the driving mode is detected, the estimation means 107 estimates the switching cause of the driving mode based on the image captured by the camera 310. For example, as illustrated in FIG. 21, when a person, a bicycle, or the like that may come into contact with the bus 300a appears in the image after switching from the automatic driving mode to the non-automatic driving mode (remote driving mode) at the destination of the bus 300a, the estimation means 107 determines that the mode has been switched to the non-automatic driving mode (remote driving mode) in order to safely pass through the area where a large number of these people exist, instead of switching of the driving mode due to an abnormality of the road. In this case, the control center device 100c inhibits transmission of the mode change information to the analysis server 400.

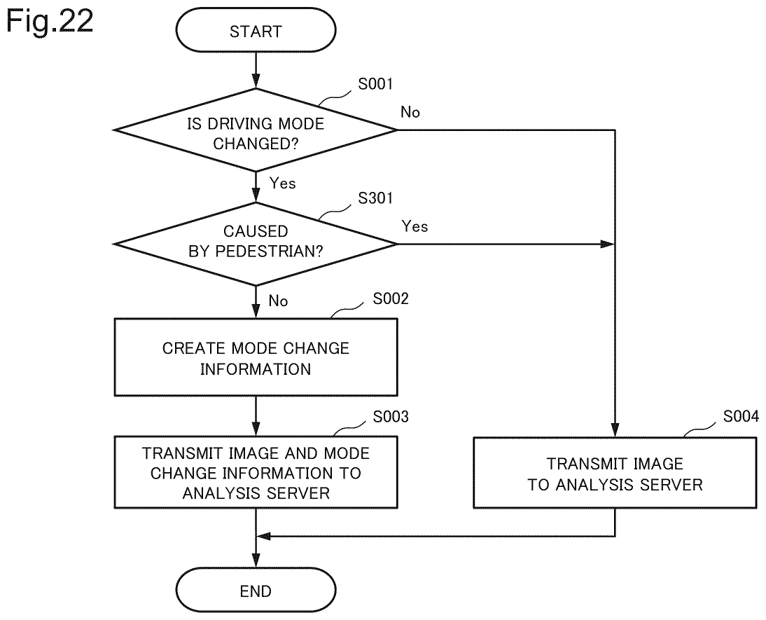

Next, the operation of the present example embodiment will be described in detail with reference to the drawings. FIG. 22 is a flowchart illustrating an operation of the control center device 100c according to the fourth example embodiment of the present invention. A difference from the operation of the control center device 100 of the first example embodiment illustrated in FIG. 8 is that, after the change of the driving mode is detected (Yes in step S001), a process in which the control center device 100c determines whether the change is a change in the driving mode caused by a pedestrian is added (step S301).

As a result of the determination, when it is determined that the change is a change in the driving mode caused by the pedestrian (Yes in step S301), the control center device 100c inhibits transmission of the mode change information to the analysis server 400 (to step S004).

On the other hand, when it is determined that the change is not a change of the driving mode caused by the pedestrian (No in step S301), the control center device 100c creates the mode change information to transmit the image and the mode change information to the analysis server 400 as in the first example embodiment (step S003). When the driving mode returns from the remote driving mode to the automatic driving mode after it is determined that the change is a change in the driving mode caused by the pedestrian, the creation and transmission of the mode change information may be omitted.

According to the present example embodiment operating as described above, it is possible to inhibit notification of switching of the driving mode to the analysis server 400 in the area where the driving mode is frequently switched. In the above description, an example in which the presence of a pedestrian or a bicycle is detected as the cause of switching of the driving mode is described, but the cause of switching of the driving mode is not limited thereto. For example, transmission of the mode change information may be similarly inhibited in a case where weather deterioration, malfunction of the camera 310, or the like is estimated from the image.

### Fifth Example Embodiment

In the first to fourth example embodiments described above, an example is described in which each of the control center devices 100 to 100c functions as an information processing device that transmits data to the analysis server 400 that is a host device. However, the information processing device may be disposed on the vehicle (bus). Hereinafter, the fifth example embodiment in which the mode change information and the image transmission function are disposed on the bus will be described.

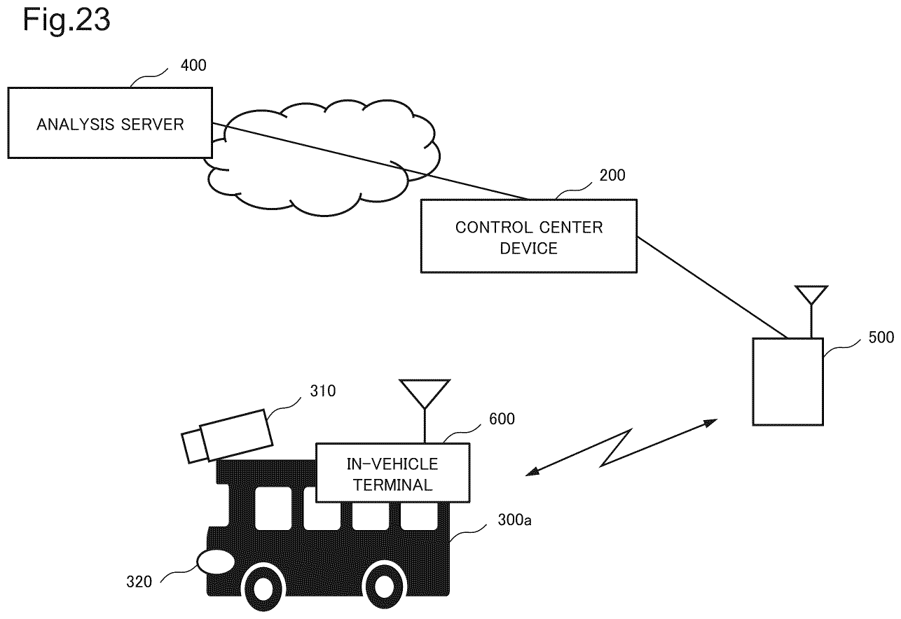

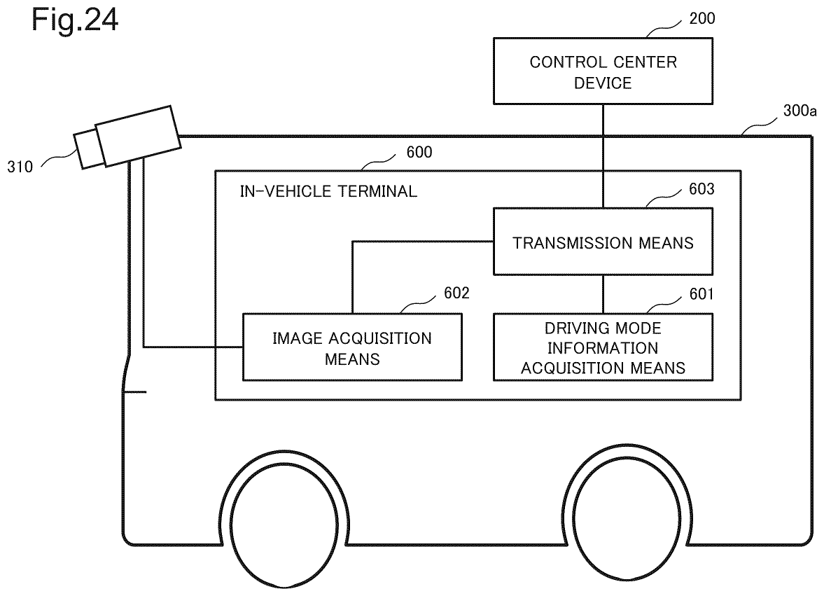

FIG. 23 is a diagram illustrating a configuration of the fifth example embodiment of the present invention. Referring to FIG. 23, a configuration including a control center device 200, the bus 300a on which the in-vehicle terminal 600 is mounted, the base station 500, and the analysis server 400 is illustrated. FIG. 24 is a functional block diagram illustrating a configuration of an in-vehicle terminal 600 according to the fifth example embodiment of the present invention. Referring to FIG. 24, a configuration of the in-vehicle terminal 600 including a driving mode information acquisition means 601, an image acquisition means 602, and a transmission means 603 is illustrated.

The driving mode information acquisition means 601 acquires driving mode information of the bus 300 from an electronic control unit (ECU) or the like of the bus 300a. When the driving mode of the bus 300 is changed, the driving mode information acquisition means 601 creates mode change information indicating the timing at which the driving mode is switched, as in the first to fourth example embodiments.

The image acquisition means 602 acquires an image from the camera 310 mounted on the bus 300a.

The transmission means 603 transmits the mode change information and the camera image in association with each other to the control center device 200 as the host device. Upon receiving the mode change information and the camera image, the control center device 200 transmits the mode change information and the camera image to the analysis server 400.

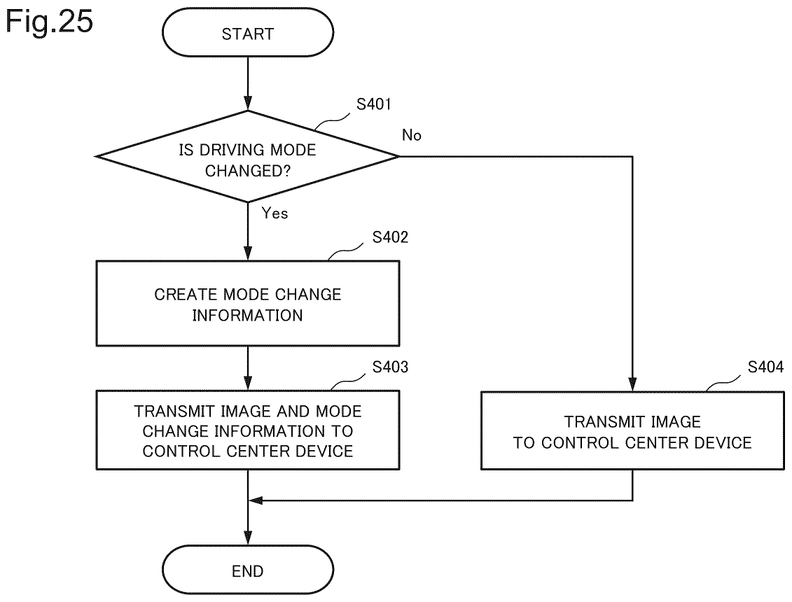

Next, the operation of the present example embodiment will be described in detail with reference to the drawings. FIG. 25 is a flowchart illustrating an operation of the in-vehicle terminal 600 according to the fifth example embodiment of the present invention. Referring to FIG. 25, first, the in-vehicle terminal 600 checks whether the driving mode has been changed (step S401).

As a result of the checking process, in a case where the driving mode is not changed, the in-vehicle terminal 600 transmits the image acquired from the camera 310 to the control center device 200 (step S404).

On the other hand, when the driving mode is changed, the in-vehicle terminal 600 creates mode change information indicating the timing at which the driving mode is switched (step S402).

Next, the in-vehicle terminal 600 transmits the mode change information and the image acquired from the camera 310 to the control center device 100 (step S403). The control center device 200 transfers the data received in step S403 or S404 to the analysis server 400.

As described above, according to the present example embodiment, the in-vehicle terminal 600 can function as an information processing device. In the above description, it is described that the in-vehicle terminal 600 has the function corresponding to the control center device 100 of the first example embodiment, but the in-vehicle terminal 600 may have the function corresponding to the control center device 100 of the second to fourth example embodiments.

Although the example embodiments of the present invention have been described above, the present invention is not limited to the above-described example embodiments, and further modifications, substitutions, and adjustments can be made without departing from the basic technical idea of the present invention. For example, the network configuration, the configuration of respective elements, and the expression form of data illustrated in the drawings are examples for assisting the understanding of the present invention, and are not limited to the configurations illustrated in the drawings.

For example, in each of the above-described example embodiments, an example in which the mobile object is a bus is described, but the mobile object is not limited to the bus. For example, the present invention can be similarly applied to a case where an image is obtained from another vehicle, an automated guided vehicle (AVG), or the like capable of switching between the automatic driving mode and the non-automatic driving mode.

### Hardware Configuration

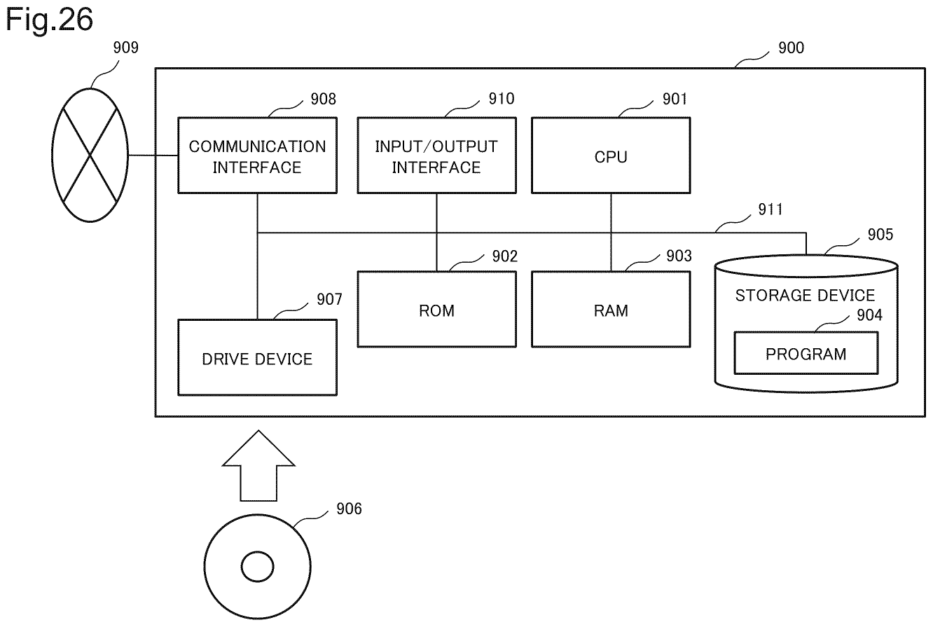

In each example embodiment of the present disclosure, each component of each device indicates a block of a functional unit. Part or all of each component of each device is achieved by, for example, an any combination of an information processing device 900 and a program as illustrated in FIG. 26. FIG. 26 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
Program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 of FIG. 26 may execute the driving mode detection program and the sensor information acquisition program to perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) program recording medium.

There are various modifications of the implementation method of each device. For example, each device may be achieved by an any combination of the information processing device 900 and the program separate for each component. A plurality of components included in each device may be achieved by any combination of one information processing device 900 and a program. That is, the present invention can be achieved by a computer program that causes the communication terminal, the network control device, and the processor mounted in these devices described in the first to third example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### Supplementary Note 1

An information processing device including
a first acquisition means for acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode,
a second acquisition means for acquiring sensor information from a sensor that determines a state of an object to be inspected, the sensor being mounted on the mobile object, and
a transmission means for transmitting, to a predetermined host device, mode change information indicating a timing at which the automatic driving mode has been switched to the non-automatic driving mode and the sensor information.

### Supplementary Note 2

The non-automatic driving mode of the information processing device described above is preferably a remote driving mode for remotely driving the mobile object or a manual driving mode for manually driving the mobile object.

### Supplementary Note 3

The first acquisition means of the information processing device described above may be further configured to acquire a timing at which the mobile object has been switched from the non-automatic driving mode to the automatic driving mode, and
the transmission means may be configured to transmit, to the predetermined host device, second mode change information indicating a timing at which the automatic driving mode has been switched to the non-automatic driving mode.

### Supplementary Note 4

In the information processing device described above,
the sensor information may be an image captured by a camera mounted on a mobile object,
the information processing device may further include an object recognition means for performing an object recognition process of recognizing an object appearing in the image, and
the transmission means may be configured to transmit a result of the object recognition process to the predetermined host device.

### Supplementary Note 5

The information processing device described above
may further includes an estimation means for estimating a cause of switching of the mobile object from the automatic driving mode to the non-automatic driving mode based on the sensor information, wherein
transmission of the mode change information may be configured to be inhibited in a case where the cause is not caused by a state of the object to be inspected.

### Supplementary Note 6

In the information processing device described above,
the information processing device may be mounted on the mobile object, and
the predetermined host device may be a control center that remotely drives the mobile object in the non-automatic driving mode.

### Supplementary Note 7

In the information processing device described above,
the information processing device may be disposed in a control center that remotely drives the mobile object in the non-automatic driving mode, and
the predetermined host device may be a server that analyzes an image received from the control center.

### Supplementary Note 8

A server including
a reception means for receiving the mode change information and the sensor information from the information processing device described above, and
a determination means for determining a state of an object to be inspected using the mode change information and the sensor information.

### Supplementary Note 9

An inspection system including
an information processing device including a first acquisition means for acquiring a timing, at which a mobile object configured to switch between at least two driving modes including an automatic driving mode in which the mobile object moves by automatic driving and a non-automatic driving mode, has been switched from the automatic driving mode to the non-automatic driving mode, a second acquisition means for acquiring sensor information from a sensor that determines a state of an object to be inspected, the sensor being mounted on the mobile object, and a transmission means for transmitting, to a predetermined host device, mode change information indicating a timing at which the automatic driving mode has been switched to the non-automatic driving mode and the sensor information, and
a server including a reception means for receiving the mode change information and the sensor information from the information processing device and a determination means for determining a state of an object to be inspected using the mode change information and the sensor information.

### Supplementary Note 10

A sensor data transmission method including
acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode,
acquiring sensor information from a sensor that determines a state of an object to be inspected, the sensor being mounted on the mobile object, and
transmitting, to a predetermined host device, the sensor information and mode change information indicating a timing at which the automatic driving mode has been switched to the non-automatic driving mode.

### Supplementary Note 11

A program recording medium recording a program for causing a computer to execute the steps of
acquiring a timing, at which a mobile object that is configured to switch between at least two driving modes including an automatic driving mode in which the mobile object moves by automatic driving and a non-automatic driving mode, has been switched from the automatic driving mode to the non-automatic driving mode,
acquiring sensor information from a sensor that determines a state of an object to be inspected, the sensor being mounted on the mobile object, and
transmitting, to a predetermined host device, the sensor information and mode change information indicating a timing at which the automatic driving mode has been switched to the non-automatic driving mode.

The forms of the Supplementary Notes 9 to 11 can be expanded to the forms of the Supplementary Notes 2 to 7, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

V1 mobile object
10 information processing device
11 first acquisition means
12 second acquisition means
13 transmission means
20 host device
PH pot hole
100, 100a, 100b, 100c, 200 control center device
101, 601 driving mode information acquisition means
102, 602 image acquisition means
103, 603 transmission means
104 remote control means
105 sensor data acquisition means
106 object recognition means
107 estimation means
300, 300a bus
310 camera
320 sensor
400 analysis server
401 reception means
402 determination means
500 base station
600 in-vehicle terminal
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus
CR crack
M1 message
OP operator
S1 heading information
S2 acceleration sensor information
V1 mobile object

What is claimed is:

1. An information processing device comprising:
at least one memory storing instructions; and
at least one processor configured to execute the instructions to:
acquire a timing, at which a mobile object that is configured to switch between at least two driving modes including an automatic driving mode in which the mobile object moves by automatic driving and a non-automatic driving mode, has been switched from the automatic driving mode to the non-automatic driving mode;
acquire sensor information from a sensor that determines a state of an object to be inspected, the sensor being mounted on the mobile object; and
transmit a predetermined host device, mode change information indicating a timing at which the automatic driving mode has been switched to the non-automatic driving mode and the sensor information.

2. The information processing device according to claim 1, wherein the non-automatic driving mode is a remote driving mode in which the mobile object is remotely driven or a manual driving mode in which the mobile object is manually driven.

3. The information processing device according to claim 1, wherein the at least one processor is further configured to execute the instructions to:
acquire a timing at which the mobile object has been switched from the non-automatic driving mode to the automatic driving mode, and
transmit the predetermined host device, second mode change information indicating a timing at which the automatic driving mode has been switched to the non-automatic driving mode.

4. The information processing device according to claim 1, wherein the at least one processor is further configured to execute the instructions to:
acquire an image captured by a camera mounted on a mobile object as the sensor information,
perform an object recognition process of recognizing an object appearing in the image, and
transmit a result of the object recognition process to the predetermined host device.

5. The information processing device according to claim 1, wherein the at least one processor is further configured to execute the instructions to:
estimate a cause of switching of the mobile object from the automatic driving mode to the non-automatic driving mode based on the sensor information; and
inhibit transmission of the mode change information in a case where the cause is not caused by a state of the object to be inspected.

6. The information processing device according to claim 1, wherein
the information processing device is mounted on the mobile object, and
the predetermined host device is a control center that remotely drives the mobile object in the non-automatic driving mode.

7. The information processing device according to claim 1, wherein
the information processing device is disposed in a control center that remotely drives the mobile object in the non-automatic driving mode, and
the predetermined host device is a server that analyzes an image received from the control center.

8-9. (canceled)

10. A sensor data transmission method comprising:
acquiring a timing at which a mobile object that is configured to switch between at least two driving modes including an automatic driving mode in which moving is performed by automatic driving and a non-automatic driving mode has been switched from the automatic driving mode to the non-automatic driving mode;
acquiring sensor information from a sensor that determines a state of an object to be inspected, the sensor being mounted on the mobile object; and
transmitting, to a predetermined host device, the sensor information and mode change information indicating a timing at which the automatic driving mode has been switched to the non-automatic driving mode.

11. A non-transitory program recording medium recording a program for causing a computer to execute the steps of:
acquiring a timing at which a mobile object that is configured to switch between at least two driving modes including an automatic driving mode in which moving is performed by automatic driving and a non-automatic driving mode has been switched from the automatic driving mode to the non-automatic driving mode;
acquiring sensor information from a sensor that determines a state of an object to be inspected, the sensor being mounted on the mobile object; and
transmitting, to a predetermined host device, the sensor information and mode change information indicating a timing at which the automatic driving mode has been switched to the non-automatic driving mode.
